(19) United States
(12) Patent Application Publication
(10) Pub. No.: US 2015/0235076 A1
(43) Pub. Date: Aug. 20, 2015

(54) METHOD FOR SHOOTING VIDEO OF PLAYING FIELD AND FILTERING TRACKING INFORMATION FROM THE VIDEO OF PLAYING FIELD

(71) Applicant: AiScreen Oy, Tampere (FI)

(72) Inventors: Pertti AIMONEN, Pirkkala (FI); Juha LAITSAARI, Hameenlinna (FI); Petja SALMELA, Tampere (FI)

(21) Appl. No.: 14/627,306

(22) Filed: Feb. 20, 2015

Related U.S. Application Data
(60) Provisional application No. 61/942,354, filed on Feb. 20, 2014.

(51) Int. Cl. G06K 9/00; G06K 9/62; G06K 9/46; H04N 7/18

(52) U.S. Cl. CPC G06K 9/00342; H04N 7/18; G06K 9/00711; G06K 9/6267; G06K 9/46

(57) ABSTRACT

Method and system for tracking objects based on video data, wherein each of a number of objects to be tracked on a playing field has been provided with at least one reflective marking configured to reflect invisible light of predefined wavelength, the method including: shooting video of the playing field utilizing one or multiple cameras sensitive to the invisible light of predefined wavelength, when moving marked objects are on the playing field, which is further illuminated during video shooting with one or multiple lamps transmitting the invisible light so as to capture images incorporating images of the reflective markings, supplying digital video image data to image processing equipment, and filtering tracking information from the digital video image data of a game situation on the playing field, wherein marked objects are searched, recognized and tracked and their movements analyzed based on recognizing the corresponding markings from the image data.

### FIELD OF THE INVENTION

Generally the present invention relates to electronics, optics and computing including object recognition. In particular, the invention pertains to tracking objects based on video image data and object related markers detectable in the image data.

### BACKGROUND

Computer vision refers to techniques for analyzing image data such as video image data to extract meaningful information therefrom. Video tracking falls under the concept of computer vision and concentrates on locating one or more moving objects of interest based on the video image data. A number of potentially overlapping cameras (having regard to the field of view) may be directed, optionally dynamically, to a desired area, such as a playing field or playing arena, whereupon the objects of interest, such as athletes participating in a game, moving in the area can be detected from the resulting video image, or ‘frame’, data based on a predefined detection logic that may be based on fixed or adaptive detection rules.

In many use contexts including team sports the objects of interest may be hard to detect and mutually identify based on ordinary image data taken with visible light registering video cameras. The tracked objects such as players may wear similar clothing, carry similar equipment, exhibit similar 2d-shape and size in the video images, and populate the same areas simultaneously in the video image, whereupon their detection from the background may impose a first challenge and true (mutual) identification another, not forgetting often even trickier and higher analysis resolution demanding recognition tasks such as detection of component or sub-object positions such as head stance.

Further, in various use scenarios merely locating or tracking individual objects such as players of a game is not sufficient or at least the ultimate in what could be achieved in terms of useful statistics and other information for exploitation by various parties such as coaches, the audience, tv watchers, etc.

### SUMMARY

The objective of the present invention is to at least alleviate one or more of the above drawbacks associated with existing solutions in the context of object tracking.

The objective is achieved with embodiments of a method and system for tracking objects based on video data.

According to one aspect of the present invention, a method for tracking objects based on video data, wherein each of a number of objects, such as players, object of play, sports equipment, and/or goals, to be tracked on a playing field, such as ice hockey rink, has been provided with at least one reflective marking, or ‘marker’, configured to reflect invisible light of predefined wavelength, comprises:

shooting video of the playing field utilizing one or multiple cameras sensitive to the invisible light of predefined wavelength, when there are moving marked objects on the playing field, wherein the playing field is illuminated during video shooting with one or multiple lamps transmitting the invisible light next to the one or multiple cameras so as to capture images incorporating images of the reflective markings provided to the objects,
supplying digital video image data to image processing equipment, and
filtering tracking information from the digital video image data of a game situation on the playing field preferably substantially in real time by the image processing equipment, wherein marked objects are searched, recognized and tracked and their movements analyzed based on recognizing the corresponding markings from the image data.

In some embodiments, the method may specifically include the step of providing the objects with the reflective markings. E.g. reflective paint, ink, patches, badges, stickers, sheets, tape, etc. defining at least part of a marking may be provided optionally under the (outer) clothing. Adhesive or e.g. hook-and-loop (e.g. Velcro™) type fastening techniques could be applied, when needed.

According to another aspect, a system for tracking objects based on video data comprises

a number of cameras sensitive to invisible light of predefined wavelength for shooting video of a playing field capturing marked objects thereon, each marked object arranged with at least one reflective marker configured to reflect the invisible light,
a number of lamps for illuminating the playing field during video shooting, said lamps being configured to transmit invisible light next to the number of cameras so as to capture video image data incorporating image data representing the reflective markings provided to the objects, and
image processing equipment configured to filter tracking information from the video image data of a game situation on the playing field preferably substantially in real time, wherein the equipment is configured to search, recognize and track the objects, and analyze their movements, based on recognizing the corresponding markers from the image data.

The system may further comprise at least some of markers to be provided to the objects. The markers may include e.g. patches of reflective material.

Different considerations presented herein regarding the embodiments of the system may be generally flexibly applied to the embodiments of the method mutatis mutandis and vice versa, as being appreciated by a skilled person.

The utility of the present invention arises from multiple issues depending on the particular embodiment in question. For example, for coaches real-time coaching decisions during the game become possible based on real data not only personal impression. Team play may be dynamically improved and thus the probability to win the game increases. Strategies between the teams on the playing field may be compared. A game heatmap (indicative of activity, may be spatial and/or temporal) may be created. Comparison of planned strategy and realized activities on the playing field may be executed. Object of play such as puck control (e.g. in critical areas vs opponent) may be analyzed as well as getting the object from the opponent, defense performance against opponent attacks near to own goal, slap shots/other shots in desired areas can be recorded as well as passes. Directional shifts of the game may be registered. During or after the game the gathered data may be analyzed even more thoroughly via different statistics regarding personal and team performances. Penalties may be analyzed (durations, causes, related scenarios, players involved, etc.). Generally, creating and updating statistics is elevated into a new level and less manpower is required for establishing those. For the fans and spectators, obtaining different key statistics and/or highlight feed becomes available, substantially in real-time. Player parameters such as speed data, distance data, as well as the speed of the object of play (e.g. puck or ball) may be recorded and optionally associated with related shot data collected. Generally, the information gathered can be used to make real-time decisions during a game, build better teams, determine individual player's abilities, and lift the crowd's experience to new heights.

The expression “a number of” may herein refer to any positive integer starting from one (1).

The expression “a plurality of” may refer to any positive integer starting from two (2), respectively.

### BRIEF DESCRIPTION OF THE DRAWINGS

Next the present invention will be described in greater detail with reference to the accompanying drawings, in which:

FIG. 1 is a top view of an embodiment of the present invention arranged to monitor a playing field such as ice hockey rink.

FIG. 2 is a top view of an embodiment of a marker arrangement relative to a player such as ice hockey player.

FIG. 3 is a block diagram of an embodiment of a system in accordance with the present invention.

FIG. 4 is a flow diagram disclosing an embodiment of a method in accordance with the present invention.

### DETAILED DESCRIPTION

In one aspect, this invention provides a method for shooting video of a playing field and filtering tracking information from the video shot of a game situation on a limited playing field substantially in real time, when there are moving objects, such as players, object of play and goals, on the field, and playing field is being shot with one or multiple cameras, and the digital video data sent by these cameras is sent to image processing equipment for searching, recognition and tracking of these mentioned objects as well as for analyzing the movements of these objects.

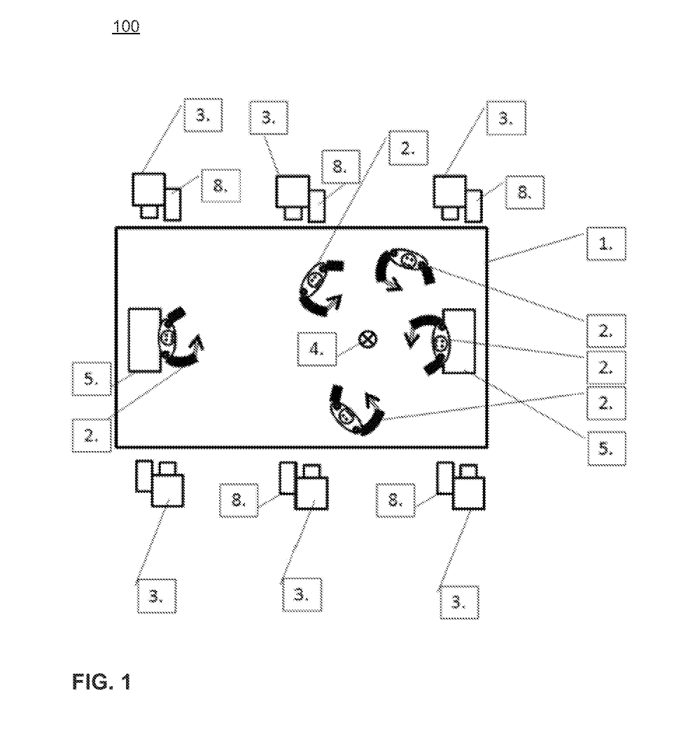

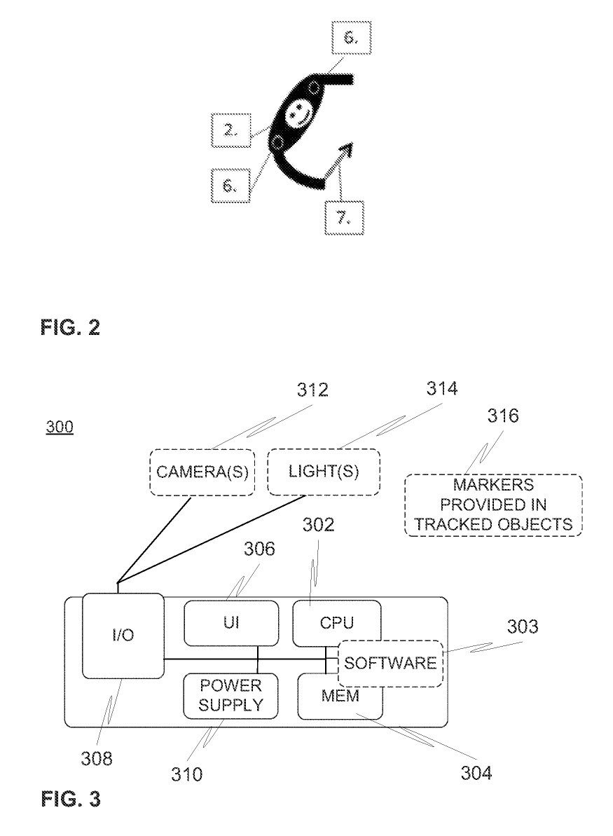

With reference to FIGS. 1 and 2, the following numerals have been used:

1—A playing field (e.g. ice hockey rink but the invention is applicable to monitor also other sports and related playing areas such as soccer/soccer field, or American football/football field, being suitable in addition to team sports also individual sports)
2—A player

### 3—Camera

4—Object of play (ball, puck, etc)

### 5—Goal

6—Reflective marking (or ‘marker’)
7—Object of play 2 (stick, club, bat, paddle, mallet, racket, racquet, flipper or other
sports equipment)

### 8—Lamp.

In FIG. 1, at 100 the merely exemplary playing field is an ice hockey rink with boards surrounding the rink, goals 5, required lines and players 2. Above and in this case also outside the playing area 1 there are cameras 3 shooting the game events. Next to cameras 3 there are lamps 8 which illuminate the playing field. These lights 8 can be NIR (near infra-red) lamps or other light sources, which transmit invisible light (electromagnetic radiation) or at least practically substantially invisible light, having regard to human vision, such as near infra-red light close to the wavelength of visible light (e.g. about 850 nm). Additionally or alternatively, UV (ultraviolet) light, IR light or other light with corresponding narrow wavelength band may be used. Use of invisible light is usually advantageous as it does not disturb or blind players, referees or spectators, for example.

Reflectors, reflecting surfaces or reflecting patterns with reflective markings 6 are situated to moving objects which are tracked on the playing area 1 so that NIR light or other used wavelength can be reflected back to camera. Cameras 3 preferably incorporate matrix video cameras sensitive to the chosen wavelength, whereupon the obtained image data shows reflecting markings 6 from objects visible to each camera 3. Unique reflecting patterns are detected from the images of cameras 3, and these patterns facilitate recognizing each object. Preferably, the cameras 3 include so-called high-resolution and high-speed cameras.

Preferably the cameras 3 are located so that no black-out areas remain in the overall field of view and each object can be tracked with at least one camera.

Besides the shooting camera(s) 3 there can be used further camera(s) sensitive to the desired (same or different) wavelength, which is/are working continuously or e.g. as synchronized with the shooting camera(s) 3, in which case e.g. sharp still images of a fast moving object of play 4 and/or player 2 and optionally related markings in chosen wavelength attached to those may be obtained, for instance.

A reflective marking 6 can also be attached or generally provided to goals 5, lines (e.g. center/red line, blue line, goal line, goal crease, faceoff spot, faceoff circle, etc. in hockey), object of play 4 such as puck, or game equipment like sticks, bats, rackets 7 or some worn game equipment (clothing, protective gear, etc.). The reflective marking may establish a reflective, distinguishable (at least by the camera) number (e.g. player number), a code, a symbol, a pattern, a letter, and/or text, for instance. The reflective marking may be configured to reflect selected wavelength(s) detectable by the cameras 3 more effectively than the remaining wavelengths.

Each marking may be unique or at least some of the markings may be similar. For example, each object such as player or a player's body part or playing equipment may carry at least one unique marking(s). Alternatively, each player may carry multiple mutually similar markings attached to different monitored locations, however other players having no similar markings. In a further scenario, members of the same team may carry similar markings.

E.g. reflective markings on the shoulders of player 2 can be located under a jersey or other clothing, since NIR light and also some other wavelengths reflect through the fabric of the jersey. Instead, visible light reflects from the jersey so that the reflective markings 6 are not visible to spectators through the jersey. There can even be for example visible advertising on shoulders or other positions on the same spot with the markings. Thus, the markings 6 may be generally located on the outer surface or under the surface of the host element (garment, gaming equipment, object of play) as long as the light reflected by the markings 6 is still visible to the cameras 3 sensitive to such light and having the markings 6 in their field of view. Reflective marking 6 can be generally produced by a variety of different techniques. They may be printed (e.g. paint or ink), embroidered or woven with a reflective thread, for instance. Marking 6 may be provided with a patch or badge, for example, attached to the host element. Alternatively, it may be provided in a material layer or sheet laminated onto or embedded in the host element, e.g. sports equipment or object of play (e.g. puck or ball). For example, a puck or other object of play may be marked using silk-screen printing, special paint, or other delicate technique so as to preserve the normal behaviour thereof on ice or other playing surface, or in the air.

In FIG. 2, player 2 is shot with a video camera from above, in which case a good spot for a reflective marking 6 in terms of video capturing could be shoulder, helmet or e.g. upper back or some other spot likely visible in the top video image. With object recognition and related object tracking suggested herein it is possible to analyze in principle all the movements, especially those of players 2 and objects of play 4, trajectories and accurate locations, such as even small shifting of goals 5 in relation to playing field. Object recognition can be facilitated remarkably by using, for example, an optical filter for the chosen wavelength in front of the camera lens to make it easier, quicker and more reliable to recognize the objects to be monitored from the camera signal/image.

In one embodiment (video) image processing equipment including image processing software is adjusted to recognize the type of a tracked player's or generally object's movement, such a shot, throw, hit, tackle/check, distance from the field surface, capture or losing of game equipment or object of play (e.g. puck), save/block, or kick by player 2 by analyzing e.g. the trajectory of reflective marking 6 in the stick, wrist, shoe, shoulder, head/helmet, or other part of the mentioned player 2 or other marked object (e.g. object of play). In addition to or instead of type, other characteristics such as speed or heading may be recognized. Speed may be determined using the location information from several video images (frames) and related time difference, for instance. Heading may be deduced from the detected geometry of markers attached to an object, for example, or from movement direction.

In one other embodiment, image processing equipment, particularly software, may be adjusted to recognize the rotation and/or the bow of trajectory of a ball used as an object of play by analysing the trajectory of reflective marking (6) reflecting light from the ball.

FIG. 3 is a block diagram 300 of an embodiment of a system in accordance with the present invention. The system may be used as presented in FIG. 1 to track moving objects on a playing field, such as soccer field, football field or ice hockey rink.

The system, which may be physically embodied in a number of, typically plurality of, elements having separate housings, e.g. server type central storage/processing unit(s) and camera/light units, but being still at least functionally connected together) may include at least one processing device 302, a memory chip 304, user interface (UI) 306, power supply 310, and a number of interfaces 308 for communication with the cameras (control and image data transfer), lights and/or external entities such as communications network and remote services/servers.

The UI 306 may include e.g. a number of buttons, switches, keys, touchpad, mouse, slide switch, roll, rotary switch, knob, stick controller, keyboard, keypad, push switch, display, loudspeaker, and/or touch-screen functionality.

The processing device 302 may include a microprocessor, a microcontroller, a digital signal processor, and/or a programmable logic chip among other options. The memory 304 may include a number of dedicated or processor-integrated memory chips, for example. The memory 304 may further refer to a hard disc, detachable memory card, optical disc, etc.

In practice, the processing unit 304 may be configured to execute video image processing software 303 that is stored in the memory 304 with raw or pre-processed data received from the cameras 312 via interface 308.

The power supply 310 may refer to internal battery, optionally rechargeable one, and/or connector for external power source, for instance.

The cameras 312 may be designed to capture, in addition to or instead of visible light, light that is substantially invisible to human eye as discussed hereinbefore. Optical filters may be applied in connection with camera optics to process the incident light as desired. For example, undesired wavelengths may be filtered away.

Software 303 may be provided as computer code or computer program product embodied in a non-transitory carrier medium such as memory card or optical disc.

Optionally, the program may be transmitted as a signal optionally wirelessly.

The interface(s) 308 may besides necessary electrical and/or optical interface(s) for communicating with the cameras 312 and lights 314 (the two being either integral or separate elements), also include a number of wired and/or wireless transfer elements such as transceivers for communication with external elements or networks. The transceiver(s) may include a landline telephone network interface or PSTN interface, a cellular network transceiver (e.g. GSM (Global System for Mobile Communications), UMTS (Universal Mobile Telecommunications System)/3G, or 4G/LTE (Long Term Evolution)), a WLAN transceiver, Bluetooth or Bluetooth Low Energy transceiver, Zigbee transceiver, or some other, potentially proprietary, transceiver.

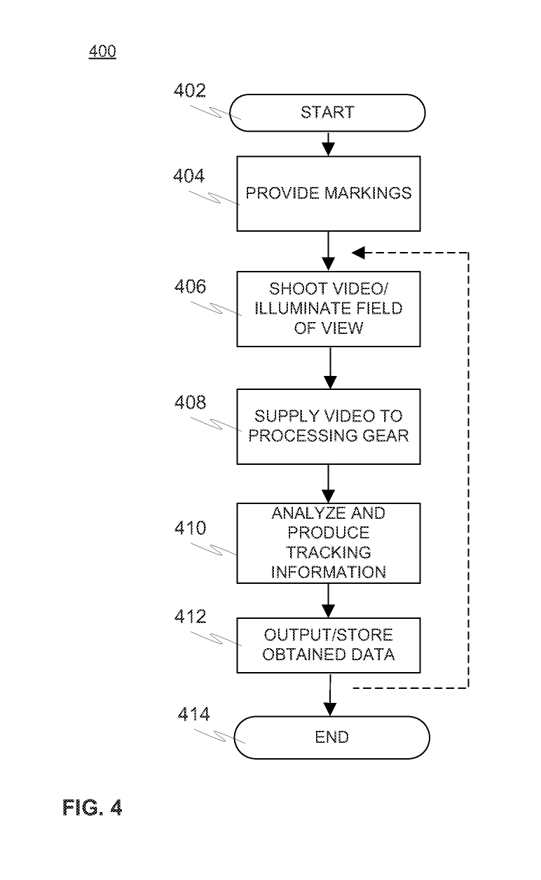

FIG. 4 shows a flow diagram 400 disclosing an embodiment of a method in accordance with the present invention. At the beginning of the method various start-up phase tasks 402 may be executed. For example, camera gear, analysis equipment, etc. may be obtained, positioned (e.g. top/overhead camera, side camera, etc.) and configured. At 404, markers may be provided to target objects by printing, using adhesive or e.g. Velcro™ tapes or patches, etc., and/or objects already integrated (laminated (heat, pressure, adhesive, etc.), molded, etc.) with markings (e.g. gaming equipment or object of play) may be obtained.

At 406, one or multiple video cameras record video data having regard to the target area, such as a playing field. Additionally, lighting (lamps) has been provided to illuminate the target area with invisible light such as the aforesaid NIR light to increase the intensity of reflections from the markers, which facilitates subsequent detection of the markers from the overall image data and thus improves the system's overall tracking capability having regard to host objects.

Each of the cameras may have been configured to focus on certain fixed target area or target space only, i.e. the field of view remains static. Alternatively, at least one camera may be targeted to cover the whole playing field and optionally further areas adjacent to it. Camera(s) may also be targeted to special areas such as team/players areas such as bench(es) and/or penalty areas such as bench(es)/box(es). For example, dedicated cameras could be targeted towards both ends of the playing field (e.g. attacking/defending zones in ice hockey) whereas a dedicated camera concentrates on the central portion (e.g. neutral zone in ice hockey). Alternatively or additionally, a number of dynamically controllable cameras may be utilized. For example, tilt/rotation, pan, zoom and/or other parameters may be controlled by the system. The cameras may include some integrated processing unit and/or memory for at least limitedly controlling or optimizing the imaging procedure and storing image data, respectively.

Pre-processing or more throughout processing of images may be optionally executed by the camera electronics. For example, unique markers may be detected and indicated from the image data and/or different preliminary image processing tasks such as low pass, high pass, noise removing, or averaging filtering may be executed. Preferably, however, at least more intensive data processing and/or control is executed by central unit or central equipment that may be remote from the cameras, obtain data from multiple cameras for e.g. synergetic processing with enhanced processing power, and be connected to the cameras using feasible communication link(s) and/or even a communication network. The link(s) may be wired (electrical and/or optical wiring) or wireless (e.g. radio frequency). Optionally, one or more of the cameras are also powered by the central equipment in addition to mere communications connection. Alternatively, they may have a power supply of their own. The cameras and/or their stands, mounting gear etc. may be provided with necessary gear for implementing the desired dynamic control. E.g. servo motors may be applied.

At 408, video data either in raw format or pre-processed form is supplied to the main image processing equipment that is preferably, however not necessarily in every embodiment, remote central type of equipment, e.g. a server, to at least several if not all or majority of the cameras. The data is provided using available communication or signalling technology, e.g. a data bus, wiring/cabling, optical cabling, or wirelessly using e.g. radio link. For example, in various sports events the cameras and illumination gear may be distributed among multiple locations to cover the target area with sufficient coverage and from necessary angles (e.g. top, overhead and/or side cameras may be used).

At 410, the image processing equipment analyses the image data obtained from one or more cameras. Automated computer vision algorithm(s) running in the equipment such as a server process the data feed obtained from the camera(s).

The utilized analysis logic, typically in the form of processor-executable software stored in memory, may have been pre-programmed or taught (trained) to detect predefined markers incorporating characterizing patterns (symbols, letters, graphics, etc.) from the image data. Reference data may be compared with image data utilizing feasible adaptation logic as being understood by a person skilled in the art to find the similarities and matches between the pre-programmed/training data and the real-life image data to detect the markers. For example, the image data may be high-pass filtered to emphasize the discontinuities/border areas therein followed by contour matching type correspondence search. Any other suitable pattern recognition techniques may be utilized as well.

Generally, relations between tracked objects (e.g. players, object of play) may be analyzed. A common synchronization reference may include e.g. time (via predefined time code and/or game clock sync) according to which the data is sorted and stored. In practice, the system may be configured to record, analyze and store the data so that the game events may be subsequently analyzed by play, reverse play, rewind, slow motion and/or fast forward type actions via the UI of the system or other device utilized for investigating the data.

A substantially real-time virtual model may be determined and maintained relative to the monitored area and detected events occurring therein. For example, location and movement vector (speed, direction) relative to the marked, moving objects may be determined and updated.

One or more event logs including detected game events associated with reference such as (game) clock, predetermined time code or generally some desired temporal reference may be established. The events may be categorized (e.g. entry into rink/playing field, movement, pass, shot, goal, penalty etc.) for subsequent facilitated analysis based on the categorization. Categorization data may be included in the logs.

In some embodiments, the system is configured to detect and record at least one event or generally, element selected from the group consisting of: game heatmap (e.g. temporal and/or spatial (e.g. defence zone, neutral zone, attacking zone)), shots towards opponent and/or own goal (total and/or per player), hits and misses (total and/or per player), penalty shots, saves/blocks (to be included e.g. in goalkeeper/-tender or goalkeeping statistics), attack/offensive strategy (e.g. pace classification such as slow, medium, fast), defence strategy (e.g. territorial, man-to-man), initial pass or pattern optionally after a game break or goaltender/goalkeeper catch/save, goalkeeper/goaltender statistics such as save percentage and/or movements, blocked shots (total and/or per player), slap shots/passes, slap shots/passes in predefined areas, breakaways, give away/take away statistics per player, object of play/puck handling ratios per player, icing, offside, shift, keeping object of play/puck in predefined area (such as attacking zone), posing object of play/puck in predefined area, player switches, gameplay per player, distance and speed for players and object of play/puck, passes, passes in predefined area, blocks, penalties (team and/or player, optionally cause and/or type (major/minor)), tackles/checks, goals, goal movement (occasionally happens e.g. in ice hockey), object of play/puck speeds (average, instant, and/or maximum), player speeds (average, instant, and/or maximum), distance (players and/or object of play), and power play and/or other special situation statistics (e.g. pattern used, number and/or type of shots, performance).

In many embodiments, team activity (involving a plurality of players or other tracked objects) may be recognized and analysed in addition to personal performances. For example, an attack or defence formation or pattern may be detected and recorded in the log for future assessment in view of e.g. preliminary game strategy and/or the overall situation in which the formation/pattern was used taking also into account e.g. the location of the object of play/puck and opponent team members.

By the embodiments of the present invention, basically every pass, slap shot, kick or other event can be sorted, analyzed and served optionally instantaneously to a number of parties such as the playing teams (e.g. management or coaches), leagues, venues and betting companies using the available data storage and transfer technologies. The solution typically requires no changes in the existing equipment. The obtained data provides insights, visibility and answers to things that have been impossible to quantify before.

Handover between multiple cameras relative to a tracked moving object may be performed. An object detected in one camera may be analyzed in terms of movement and likely switchover point and/or time from the field of view of the camera to another be calculated through extrapolation. The system may be thus ready for the change and rapidly recognize the same object in the data provided by new camera. In the case of movable or generally physically controllable cameras, tracking may be used to control camera movements so that the camera follows (tilt, rotation, pan, zoom, etc.) a moving object and maintains it in the field of view.

By the performed analysis, the success of a selected/detected game strategy may be quickly assessed and e.g. new strategy adopted if the performance looks bad enough. Performance indicators may be automatically calculated from the image data based on predefined rules and detected game strategy and/or situation.

For example, heatmap information may be very useful. If the heat is near a team's own goal or generally at the defence end (i.e. play events take place there, players are there, and/or object of play is there), it is likely that the game result will be sub-optimum. The heat should be in the opponent's area instead. Thus the game strategy should be changed. The system may even be configured to suggest a new strategy such as new player formation based on the detected or programmed current one and recognized game events indicative of current (sub-optimum) performance.

At 412, the processing results may be stored and/or transmitted forward. The dotted loop-back arrow depicts the likely repetitive nature of various method items. As the execution may occur substantially in real-time fashion in parallel with events to be monitored in the target area, suitable size of data chunks (e.g. one or multiple video frames at a time) may be processed at a time meanwhile new data is buffered for subsequent processing. Therefore, a skilled person acknowledges the fact that many of the shown method items may also occur in parallel/simultaneously in real-life scearios, considering e.g. shooting new video 406 and processing 410 previously captured frame(s).

At 414, method execution is ended.

The scope of the present invention is determined by the attached claims together with the equivalents thereof. A person skilled in the art will appreciate the fact that the disclosed embodiments were constructed for illustrative purposes only, and the innovative core of the suggested solution reviewed hereinbefore will cover further embodiments, embodiment combinations, variations and equivalents that better suit each real-life use case.

In the above, passive markers were discussed. In addition or alternatively, in some embodiments of the present invention active markers could be applied. In certain use scenarios, active markings could add to the recognition capability of the system. The visibility of the markings could be increased at least relative to the imaging gear of the cameras or subsequent processing tools.

For example, an active marker (e.g. patch, sticker, etc.) could be configured to change pattern or other emitted and/or reflected indication, and/or pulsate (e.g. alternately dim and brighten up) using a predefined frequency. Active marker may include electroluminescence (EL) based element such as electroluminescent coating, or other radiating element. Still, UV/EL or other radiating band, patch, sticker, or tape could be used. The marker may be still be wearable as was the case with the passive ones. Active and passive marking technology may be combined in the same marker as well.

Alternatively or additionally, light sources such as LEDs (light-emitting diode) or OLEDs (organic LED) could be utilized in the markers. Accordingly, the markers could be provided with necessary power sources such as batteries. Still, the emitted radiation may be invisible to human viewers but detectable by the cameras.

Instead of sports, the embodiments of the present invention may easily find use in other contexts such as security/surveillance and traffic monitoring.

1. A method for tracking objects based on video data, wherein each of a number of objects to be tracked on a playing field, such as ice hockey rink, has been provided with at least one reflective marking configured to reflect invisible light of predefined wavelength, the method comprising:
shooting video of the playing field utilizing one or multiple cameras sensitive to the invisible light of predefined wavelength, when there are moving marked objects on the playing field, wherein the playing field is further illuminated during video shooting with one or multiple lamps transmitting the invisible light so as to capture images incorporating images of the reflective markings provided to the objects,
supplying digital video image data to image processing equipment, and
filtering tracking information from the digital video image data of a game situation on the playing field preferably substantially in real time by the image processing equipment, wherein marked objects are searched, recognized and tracked and their movements analyzed based on recognizing the corresponding markings from the image data.

2. The method of claim 1, comprising recognizing the heading, movement type or movement speed of a tracked object, such as player or object of play.

3. The method of claim 1, comprising generating a heatmap indicative of the spatial or temporal distribution of marked objects and/or related detected game events.

4. The method of claim 1, wherein static or substantially static objects, such as lines on the playing field or goals, are provided with invisible markings detectable by the cameras.

5. The method of claim 1, wherein the invisible light comprises infrared, near infrared or ultraviolet light.

6. The method of claim 1, wherein there further are active markings emitting invisible radiation detectable by the cameras in connection with the reflective markings or in isolation provided to the objects.

7. The method of claim 1, wherein at least two objects have been provided with mutually distinguishable marking to identify the objects based on the recognition of the particular marking from the video image data.

8. The method of claim 1, wherein at least one event log is established based on the recognized and tracked objects, using temporal reference such as game clock or some other predefined time reference.

9. The method of claim 1, wherein game events detected based on recognized marked objects are classified according to a predefined classification.

10. A system for tracking objects based on video data, comprising
a number of cameras sensitive to invisible light of predefined wavelength for shooting video of a playing field, capturing marked objects thereon, each marked object arranged with at least one reflective marker configured to reflect the invisible light,
a number of lamps for illuminating the playing field during video shooting, said lamps being configured to transmit the invisible light so as to capture video image data incorporating image data representing the reflective markings provided to the objects, and
image processing equipment configured to filter tracking information from the video image data of a game situation on the playing field preferably substantially in real time, wherein the equipment is configured to search, recognize and track the objects, and analyze their movements, based on recognizing the corresponding markers from the image data.

11. The system of claim 10, comprising at least one server for hosting at least part of the image processing equipment, the cameras being remote therefrom.

12. The system of claim 10, comprising a plurality of markers, optionally patches, stickers, or tape, to be provided to the objects for subsequent detection by the cameras.
